(19) United States
(12) Patent Application Publication
(10) Pub. No.: US 2020/0086988 A1
(43) Pub. Date: Mar. 19, 2020

(54) AERIAL VEHICLES WITH BLADELESS PROPELLERS

(71) Applicant: SANDEEP KUMAR CHINTALA, LONDON (GB)

(72) Inventors: SANDEEP KUMAR CHINTALA, LONDON (GB); SRIRANJAN RASAKATLA, SHAMSHABAD HYDERABAD (IN)

(21) Appl. No.: 16/493,847

(22) PCT Filed: Mar. 13, 2018
(86) PCT No.: PCT/GB2018/050629

§ 371 Date: Sep. 13, 2019

(30) Foreign Application Priority Data
Mar. 13, 2017 (IN) 201741008602

(51) Int. Cl. B64C 39/02; B64C 25/06; F04F 5/16

(52) U.S. Cl. CPC B64C 39/024; B64C 25/06; B64C 2201/162; B64C 2201/042; B64C 2201/027; F04F 5/16

(57) ABSTRACT

The present subject matter relates to an aerial vehicle (100). The aerial vehicle (100) comprises a main body (102) having at least one suction motor (104) to suck-in atmospheric air, to amplify the sucked air and to eject the amplified air. The aerial vehicle (100) comprises at least one thrust shoot (106) coupled to the at least one suction motor (104), through which the ejected amplified air from the at least one suction motor (104) passes out through an opening of the at least one thrust shoot (106). The air is modulated for creating a differential thrust for manoeuvring of the aerial vehicle (100).

### TECHNICAL FIELD

The present subject matter relates, in general, to aerial vehicles, and in particular, to aerial vehicles with bladeless propellers.

### BACKGROUND

Aerial vehicles of various sizes and shapes are becoming increasingly prevalent in various aspects of our life. Besides the aerial vehicles used for transport, such as aeroplanes and helicopters, aerial vehicles, such as unmanned aerial vehicles (UAV) are also being developed for niche applications, such as surveillance, search and rescue, research, military reconnaissance, delivery of goods etc.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the figures to reference like features and components. Some implementations of the aerial vehicles, in accordance with the present subject matter, are described by way of examples, and with reference to the accompanying figures, in which:

FIG. 1 illustrates a schematic representation of an aerial vehicle in accordance with an implementation of the present subject matter;

FIG. 2 illustrates a partial side perspective view of an aerial vehicle in accordance with an implementation of the present subject matter;

FIG. 3 illustrates a schematic representation of a directional vent in accordance with an implementation of the present subject matter;

FIG. 4 illustrates a schematic representation of a differential thrust mechanism in accordance with an implementation of the present subject matter;

FIG. 5 illustrates a perspective view of an aerial vehicle having a landing frame, in accordance with another implementation of the present subject matter;

FIG. 6 illustrates a perspective view of an aerial vehicle in accordance with yet another implementation of the present subject matter; and

FIG. 7 illustrates a block diagram of an aerial vehicle in accordance with an implementation of the present subject matter.

### DETAILED DESCRIPTION

Aerial vehicles typically employ rotors or jets for propulsion. Besides using aerodynamic wings and tails for lift and direction, some aerial vehicles, such as helicopters and drones, are also known to use a combination of rotors to perform lift off, hovering, flying forwards, flying backwards and also move laterally. Such aerial vehicles may be designed as bi-copters, tri-copters, quad-copters etc., depending on the number of rotors being used for manoeuvrability. Such rotors typically use one or more fan blades in operation to achieve the desired lift or direction.

More recently, instead of using fan blades based rotors to achieve thrust, aerial vehicles with bladeless propellers are manufactured. The aerial vehicles with bladeless propellers use hollow propellers to push out air at high velocities for propulsion. Such hollow propellers use the principal of air multiplication, similar to that of a Dyson Air Multiplier™ used in Dyson fans, to generate a constant, high velocity and streamlined air flow. In one example, bladeless propellers use a suction motor to first draw in air and later eject the air out at high velocities to get a thrust for propulsion. Further, for addressing varied applications of the aerial vehicles, the aerial vehicles are required to have appropriate propulsion and manoeuvring mechanisms.

However, the conventional designs of aerial vehicle implementing bladeless propellers use complicated manoeuvring mechanisms such as tilting or pivoting a base of the fan or the ring to direct the air flow to gain propulsion in a desired direction. In another example of the conventional designs of the aerial vehicles, additional mechanisms, such as aerodynamic wings or tails, are employed for lift and movement in the desired direction. Such arrangements in the conventional designs of the aerial vehicles typically involve multiple parts such as motors, rotating shafts, hydraulics, etc. Implementing such designs with multiple parts is a complicated process. Further, maintenance and repair of such aerial vehicles is a difficult process due to involvement of multiple parts.

To this end, the present subject matter describes an aerial vehicle in which air is modulated to provide a differential thrust for manoeuvring of the aerial vehicle.

In an implementation of the present subject matter, the aerial vehicle includes a main body having at least one suction motor. The at least one suction motor is to suck-in atmospheric air, to amplify the sucked air and to eject the amplified air. Further, the aerial vehicle includes at least one thrust shoot coupled to the at least one suction motor, through which the ejected amplified air from the at least one suction motor passes out through an opening of the at least one thrust shoot. The air is modulated for creating a differential thrust for manoeuvring of the aerial vehicle.

In an implementation of the present subject matter, the sucked amplified air is modulated for creating a differential thrust for manoeuvring of the aerial vehicle. In such an implementation, the thrust shoot of the aerial vehicle may include a directional vent. The directional vent includes at least one flap moveable along an axis transverse to a longitudinal axis of the at least one thrust shoot for modulating the air to be passed out via the opening of the at least one thrust shoot. The modulated air results into a differential thrust for manoeuvring of the aerial vehicle.

In another implementation of the present subject matter, the air is modulated before being sucked by the suction motor for creating a differential thrust for manoeuvring of the aerial vehicle. In such an implementation, a main body includes a plurality of suction motors. Each suction motor of the plurality of suction motors is to suck-in atmospheric air, to amplify the sucked air and to eject the amplified air. Further, the aerial vehicle includes a plurality of thrust shoots, each coupled to a respective suction motor of the plurality of suction motors, through each thrust shoot of the plurality of thrust shoots, the ejected amplified air from the respective suction motor passes out from an opening of a respective thrust shoot of the plurality of thrust shoots.

In one example, the aerial vehicle includes a plurality of impellers, each disposed over a respective suction motor of the plurality of suction motors. For each impeller of the plurality of impellers, a different speed is set for creating a differential thrust for manoeuvring of the aerial vehicle.

In another example, the main body comprises a vent, disposed over the plurality of suction motors, to suck in atmospheric air from the top of the aerial vehicle prior to being sucked in by the suction motor. The vent comprises a plurality of auxiliary flaps and a plurality of axes, each axis of the plurality of axes is transverse to an axis of rotation of each suction motor of the plurality of suction motors. Each flap of the plurality of auxiliary flaps is moveable along a respective axis of the plurality of axes for modulating the air above the aerial vehicle to be sucked by each suction motor of the plurality of suction motors. The movement of each flap ensures that the modulated air enters into the plurality of suction motors so as to create a differential thrust for manoeuvring of the aerial vehicle.

With the implementations of the present subject matter, the mechanism of the present subject matter to modulate air flow out of the thrust shoots to create a resultant thrust is much simpler as opposed to complicated arrangements of the conventional aerial vehicles. Further, the aerial vehicle of the present subject matter eliminates involvement of multiple parts such as motors, rotating shafts, hydraulics, etc required for manoeuvring of the aerial vehicle. Implementing designs of the present subject matter is a simple process. Further, maintenance and repair of aerial vehicles of the present subject is a simple process due to less number of components required for manoeuvring of the aerial vehicle.

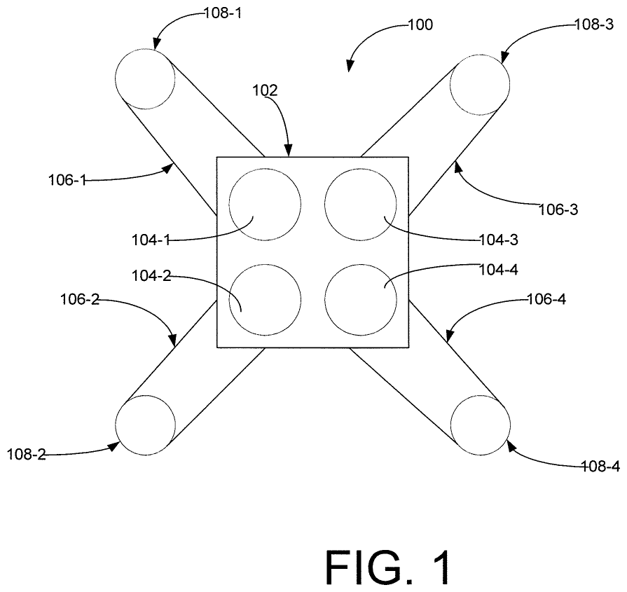

The above described aerial vehicle with bladeless propellers is further described with reference to FIG. 1 to 7. It should be noted that the description and figures merely illustrate the principles of the present subject matter along with examples described herein and, should not be construed as a limitation to the present subject matter. It is thus understood that various arrangements may be devised that, although not explicitly described or shown herein, include the principles of the present subject matter. Moreover, all statements herein reciting principles, aspects, and examples of the present subject matter, as well as examples thereof, are intended to encompass equivalents thereof.

FIG. 1 illustrates a schematic representation of an aerial vehicle 100 in accordance with an implementation of the present subject matter. The aerial vehicle 100 includes a main body 102 having one or more suction motors 104-1, 104-2, 104-3, 104-4 (collectively referred to as suction motor(s) 104) and one or more thrust shoots 106-1, 106-2, 106-3, 106-4 (collectively referred to as thrust shoot(s) 106) coupled to the suction motor(s) 104. In one example, the one or more suction motors 104 may be referred to as a plurality of suction motors 104. In another example, the one or more thrust shoots 106 may be referred to as a plurality of thrust shoots 106. Further, each thrust shoot 106 comprises an opening 108-1, 108-2, 108-3, 108-4 (collectively referred to as opening(s) 108). In an implementation of the present subject matter, the one or more suction motors 104 in the main body 102 of the aerial vehicle 100 suck in atmospheric air from the vicinity of the aerial vehicle 100 and provide amplified air flow at high velocities and further ejects the amplified air. In another implementation of the present subject matter, the suction motor(s) 104 may perform aerodynamic air multiplication for amplified air flow in a manner similar in principal to a Dyson Air Multiplier™. In one example, the suction motor 104 may be a central suction motor. In one example, the thrust shoot 106 may be a substantially hollow tubular structure, coupled immovably to the main body 102 of the aerial vehicle 100.

In one implementation of the present subject matter, the aerial vehicle 100 includes a power supply system (not shown) for power supply of entire aerial vehicle 100. In one example, the power supply system may be perpetual energy system to provide power to entire aerial vehicle 100. In another example, the power supply system may be a wireless power supply system over the air capabilities via magnetic, radio, ultrasound, acoustics, Light Fidelity or any other means. In yet another example, the power supply system may be solar or photovoltaic system to power the entire aerial vehicle 100.

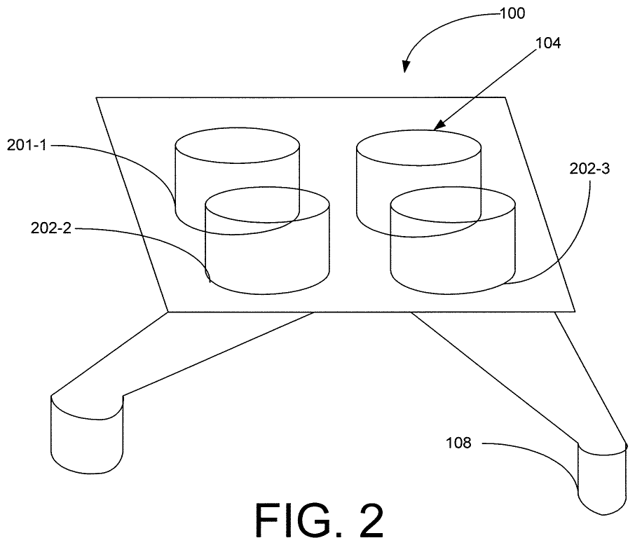

In operation of the aerial vehicle 100, the amplified air from the one or more suction motors 104 is directed into a plurality of base ends 202-1, 202-2, 202-3, . . . (collectively referred to as base end(s) 202), each associated to a respective suction motor 104 of the one or more suction motors 104, as depicted in FIG. 2. FIG. 2 illustrates a side perspective view of an aerial vehicle 100 in accordance with an implementation of the present subject matter. The thrust shoots 106 form the arms of the aerial vehicle 100. The arms of the aerial vehicle 100 support the aerial vehicle 100 on a plane in non-operational condition. In some implementations, one suction motor 104 may be associated with more than one thrust shoots 106. In such an implementation, the amplified air flow may be divided equally among the more than one thrust shoots 106. In other implementation of the present subject matter, more than one suction motor 104 may be associated with one thrust shoot 106.

Returning to FIG. 1, the amplified air flow from the suction motors 104 then passes through each thrust shoot 106. Thereafter, the amplified air is ejected from each opening 108 of the respective thrust shoot 106 thereby providing a thrust resulting in take-off of the aerial vehicle 100. The air is modulated for creating a differential thrust for manoeuvring of the aerial vehicle 100. By modulating the air passing out of each thrust shoot 106 independently, a differential thrust can be created at the opening 108 of each thrust shoot. The aerial vehicle 100 then moves in the direction of the resulting force due to the creation of the differential thrust.

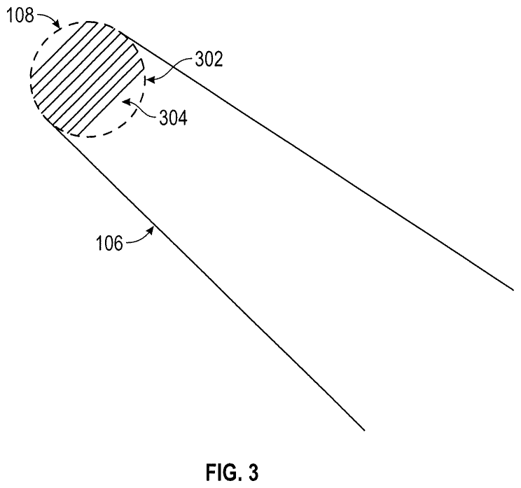

In one implementation of the present subject matter, the sucked amplified air is modulated for creating a differential thrust for manoeuvring of the aerial vehicle 100. Each thrust shoot comprises a directional vent 302, as depicted in FIG. 3, for controlling the flow of air passed via the at least one thrust shoot 106. FIG. 3 illustrates a schematic representation of the directional vent 302 in accordance with an implementation of the present subject matter. The directional vent 302 in the thrust shoot 106 to controls flow of air passing through the thrust shoot 106. In one example, the directional vent 302 may be present on each of the thrust shoots 106.

In one implementation of the present subject matter, the directional vent 302 may include one or more flaps 304. In one example, each flap 304 may be actuated by a servo motor. In one example, each flap 304 may be actuated by a stepper motor. In one implementation, the directional vent 302 may be present close to a distal end of each thrust shoot 106. In one example, the distal end may be the opening 108. In another example, the directional vent 302 is disposed at the opening 108 of the at least one thrust shoot 106. Further, each flap 304 is moveable along an axis transverse to a longitudinal axis of the at least one thrust shoot 106 for modulating the air to be passed out via the opening 108 of the at least one thrust shoot 106. In one example, the flaps 304 may be designed to move for changing the direction and intensity of air ejecting out of each thrust shoot 106. By appropriately setting the directional vent 302 for each thrust shoot 106 independently, the direction and intensity of airflow out of the thrust shoots 106 may be controlled and a thrust in the desired direction may be achieved.

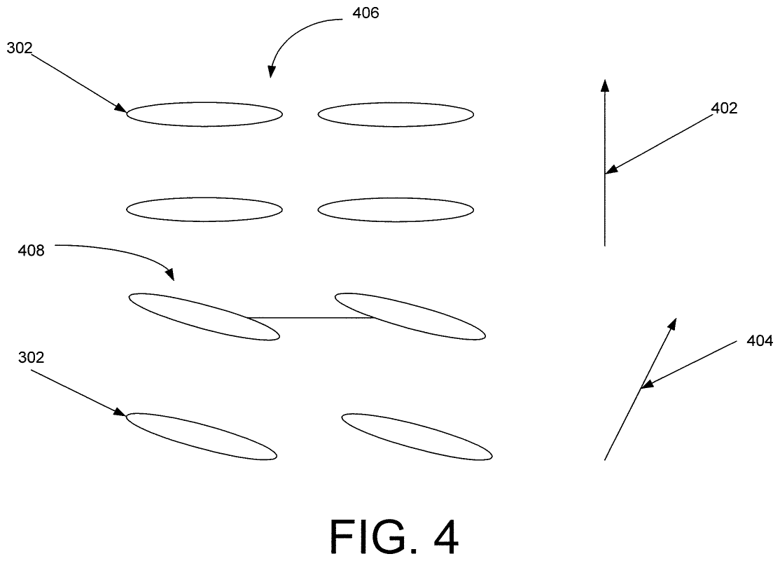

FIG. 4 illustrates a schematic representation of a differential thrust mechanism in accordance with an implementation of the present subject matter. The mechanism of the differential thrust in an aerial vehicle 100 incorporating the above-mentioned implementation is consisting of four suction motors 104 and four thrust shoots 106 arranged 90° to each other in a plane of the aerial vehicle 100. Each thrust shoot 106 is powered by one suction motor 104. Further, each thrust shoot 106 includes the directional vent 302. For ease of illustration, only a simplified representation of the plane of the directional vents 302 is shown in FIG. 4. As depicted in FIG. 4, when all the directional vents 302 are aligned such that an equal thrust is present at the distal ends of the thrust shoots 106 in a vertically downward direction 406, the aerial vehicle moves up in a vertical direction 402. In another example of the present subject matter, when the directional vents 302, on all thrust shoots 106 are so aligned that the air flow ejects with an equal thrust at a common angle to a vertical direction 408, the aerial vehicle 100 moves in a forward direction as well as a vertical direction 404. It may be understood that with different alignments of the directional vents 302, all other directions for manoeuvring can be realized.

In another implementation of the present subject matter, the air is modulated before being sucked by each suction motor 104 of the plurality of suction motors 104 for creating a differential thrust for manoeuvring of the aerial vehicle 100.

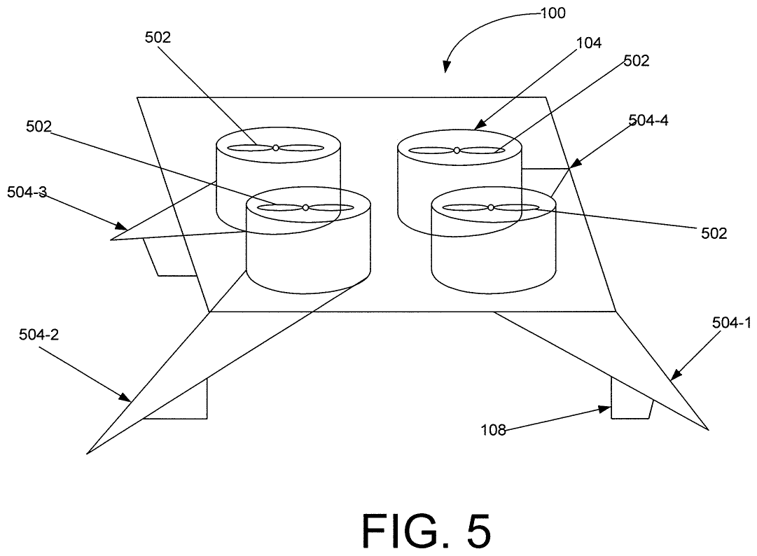

In an alternative implementation of the present subject matter, the amount of airflow out of the thrust shoot 106 may be controlled using the central suction motors 104 themselves. In an example implementation of the present subject matter, the aerial vehicle 100 includes multiple central suction motors 104 and an equal number of corresponding thrust shoots 106. Each suction motor 104 includes an impeller 502, as depicted in FIG. 5. FIG. 5 illustrates a perspective view of an aerial vehicle 100 in accordance with another implementation of the present subject matter. The main body 102 of the aerial vehicle 100 includes a plurality of suction motors 104. Each suction motor 104 of the plurality of suction motors 104 is to suck-in atmospheric air, to amplify the sucked air and to eject the amplified air. Further, the aerial vehicle 100 includes a plurality of thrust shoots 106, each coupled to a respective suction motor 104 of the plurality of suction motors 104, through each thrust shoot 106 of the plurality of thrust shoots 106, the ejected amplified air from the respective suction motor 104 passes out from an opening 108 of a respective thrust shoot 106 of the plurality of thrust shoots 106. The air is modulated before being sucked by each suction motor 104 of the plurality of suction motors 104 for creating a differential thrust for maneuvering of the aerial vehicle 100.

Further, a plurality of impellers 502 in each case is disposed over a respective suction motor 104 of the plurality of suction motors 104. In one example, the suction motor 104 may be placed such that the air is sucked in from the top of the aerial vehicle 100. For each impeller 502 of the plurality of impellers 502, a different speed is set for creating a differential thrust for manoeuvring of the aerial vehicle 100. In operation, by independently setting a different speed for each impeller 502 for each central suction motor 104, a resulting thrust may be created. The aerial vehicle 100 would then move in a resulting direction.

In one implementation of the present subject matter, the thrust shoots 106 may also be designed to provide structural advantages such as integrated landing assembly. In such an example, each thrust shoot 106 comprises a distal end extended beyond the opening 108 of at least one thrust shoot for providing a landing frame 504-1, 504-2, 504-3, . . . (collectively referred to as landing frame(s) 504).

In the implementations of the present subject matter, the suction motors 104 are provided in the main body 102 of the aerial vehicle 100 to suck in the air. In an example implementation, the suction motors 104 may be placed such that the air is sucked in from the bottom of the aerial vehicle 100.

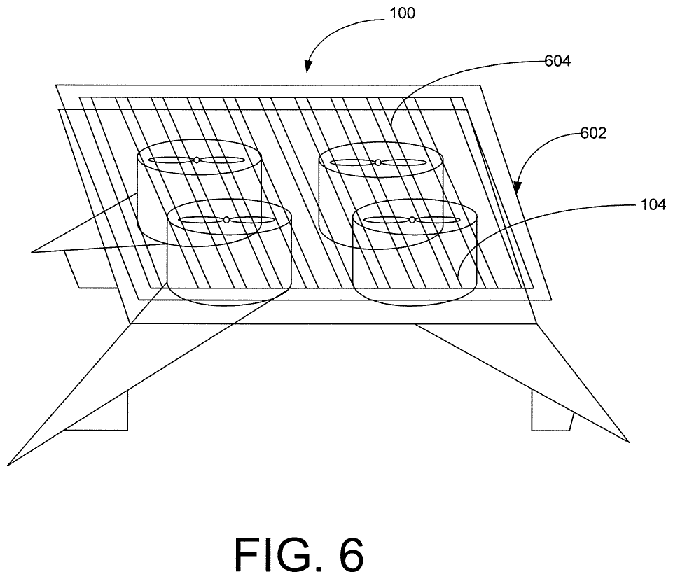

FIG. 6 illustrates a perspective view of an aerial vehicle 100 in accordance with yet another implementation of the present subject matter. In yet another implementation of the present subject matter, a vent 602 may be provided along with the suction motor 104 to suck in air from the top of the aerial vehicle 100. The main body 102 comprises the vent 602, disposed over the least one suction motor 104, to suck in air from the top of the aerial vehicle 100. The vent 602 comprises at least one auxiliary flap 604 moveable along an axis transverse to an axis of rotation of the least one suction motor 104 for modulating the air above the aerial vehicle 100 to be sucked by the least one suction motor 104.

In another example, the main body 102 comprises the vent 602, disposed over the plurality of suction motors 104, to suck in atmospheric air from the top of the aerial vehicle 100. The vent 602 comprises a plurality of auxiliary flaps 604 and a plurality of axes, each axis of the plurality of axes is transverse to an axis of rotation of each suction motor 104 of the plurality of suction motors 104. Each flap 604 of the plurality of auxiliary flaps 604 is moveable along a respective axis of the plurality of axes for modulating the air above the aerial vehicle 100 to be sucked by each suction motor 104 of the plurality of suction motors 104.

The vent 602 with flaps 604 changes the velocity of the air above the aerial vehicle 100 and causes a low-pressure region above the aerial vehicle 100 resulting in a net upward thrust. The inner vent 602 therefore has the added advantage of providing lift to the aerial vehicle 100. It may be understood that the number of vents 602 may be one or more depending on the application in mind. For example, when the aerial vehicle 100 application is for a low altitude, hovering, flying car, then a single vent 602, such as that depicted in FIG. 6, would suffice irrespective of the number of suction motors 104. This is because mainly a few directions, such as forward, reverse, lateral movement, etc. may be required for the aerial vehicle 100. For such applications, the one vent 602 may be useful only as a means to get better balance and stability for the flying car. However, when the aerial vehicle 100 application is for a military use, then a lot more manoeuvring and control is desired. In such cases, it may be understood that one inner vent 602 per suction motor 104 may be provided.

In some implementations of the present subject matter, the number of thrust shoots 106 may be more than one.

In some particular implementations, the number of thrust shoot 106 may be one. Such designs would allow the movement of the aerial vehicle 100 only in the up-down and forward-back direction.

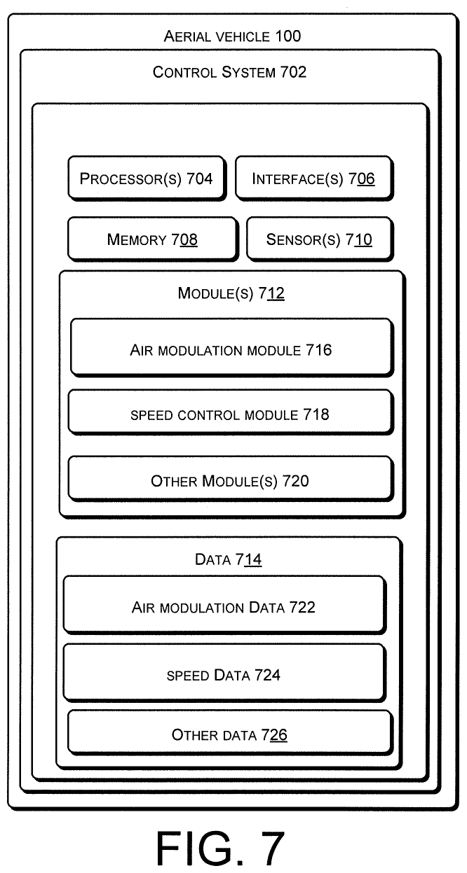

FIG. 7 depicts a block diagram of an exemplary aerial vehicle 100, as per an implementation of the present subject matter. The aerial vehicle 100 comprises a control system 702, which is implemented as a computing-device, for carrying out controlling of manoeuvring of the aerial vehicle 100. The control system 702 may be implemented as a stand-alone computing device. Examples of such computing devices include electronic control unit (ECU), a controller or any other form of computing devices. Continuing with the present implementation, the control system 702 may further include one or more processor(s) 704, interface(s) 706, memory 908 and sensor(s) 710. The processor(s) 704 may also be implemented as signal processor(s), state machine(s), logic circuitries, and/or any other device or component that manipulate signals based on operational instructions.

The interface(s) 706 may include a variety of interfaces, for example, interfaces for data input and output devices, referred to as I/O devices, storage devices, network devices, and the like, for communicatively associating the control system 702 with one or more other peripheral devices. The peripheral devices may be input or output devices communicatively coupled with the control system 702. The interface(s) 706 may also be used for facilitating communication between the control system 702 and various other computing devices connected in a network environment. The memory 708 may store one or more computer-readable instructions, which may be fetched and executed for carrying out the maneuvering. The memory 708 may include any non-transitory computer-readable medium including, for example, volatile memory, such as RAM, or non-volatile memory such as EPROM, flash memory, and the like.

The sensor(s) 710 may include a variety of sensors which may detect an air inflow, air density and other air related parameters.

The control system 702 may further include module(s) 712 and data 714. The module(s) 712 may be implemented as a combination of hardware and computer-readable instructions to implement one or more functionalities of the module(s) 712. In one example, the module(s) 712 includes an air modulation module 716, a speed control module 718, and other module(s) 720. The data 714 on the other hand includes air modulation data 722, speed data 724, and other data 726.

In examples described herein, such combinations of hardware and computer-readable instructions may be implemented in a number of different ways. For example, the computer-readable instructions may be processor executable instructions stored on a non-transitory machine-readable storage medium and the hardware for the module(s) 712 may include a processing resource (e.g., one or more processors), to execute such instructions. In the present examples, the machine-readable storage medium may store instructions that, when executed by the processing resource, implement module(s) 712 or their associated functionalities. In such examples, the control system 702 may include the machine-readable storage medium storing the instructions and the processing resource to execute the instructions, or the machine-readable storage medium may be separate but accessible to control system 702 and the processing resource. In other examples, module(s) 712 may be implemented by electronic circuitry.

The control system 702 is configured to ensure that air is modulated to provide a differential thrust for manoeuvring of the aerial vehicle so that complicated mechanisms required to manoeuvre the aerial vehicle may be avoided.

In operation of the aerial vehicle as per an implementation of the present subject matter, the air modulation module 716 may control the air flow parameters to control the airflow through the thrust shoots 704 for moving the aerial vehicle 100 in a desired direction. The air flow parameters may be set by the air modulation module 716 using directional vents 302 or controlling the speed of the impeller 502 of the suction motors 104 or both. In other implementations, a flight path is set in the memory, and the air modulation module 716 may control the air flow parameters accordingly. The speed control module 718 may then continuously and autonomously provide the appropriate modulations to the air to manoeuvre the aerial vehicle 100 along the course of the flight path.

I/we claim:

1. An aerial vehicle (100) comprising:
a main body (102) having at least one suction motor (104), wherein the at least one suction motor (104) is to suck-in atmospheric air, amplify the sucked air and eject the amplified air; and
at least one thrust shoot (106) coupled to the at least one suction motor (104), through which the ejected amplified air from the at least one suction motor (104) passes out through an opening (108) of the at least one thrust shoot (106),
wherein the air is modulated to create a differential thrust to manoeuvre the aerial vehicle (100).

2. The aerial vehicle (100) as claimed in claim 1, wherein the at least one thrust shoot (106) comprises a directional vent (302) to control the flow of air passed via the at least one thrust shoot (106).

3. The aerial vehicle (100) as claimed in claim 2, wherein the directional vent (302) is disposed at the opening of the at least one thrust shoot (106).

4. The aerial vehicle (100) as claimed in claim 2, wherein the directional vent (302) comprises at least one flap (304) moveable along an axis transverse to a longitudinal axis of the at least one thrust shoot (106) to modulate the air to be passed out via the opening (108) of the at least one thrust shoot (106).

5. The aerial vehicle (100) as claimed in claim 1, wherein the at least one thrust shoot (106) comprises a distal end extended beyond the opening (108) of at least one thrust shoot (106) to provide a landing frame (504).

6. The aerial vehicle (100) as claimed in claim 1, comprising:
a plurality of impellers (502), wherein for each impeller (502) of the plurality of impellers (502), a different speed is set to create a differential thrust to manoeuvre the aerial vehicle (100).

7. The aerial vehicle (100) as claimed in claim 1,
wherein the main body (102) comprises a vent (602), disposed over the least one suction motor (104), to suck in air from the top of the aerial vehicle (100);
wherein the vent (602) comprises at least one auxiliary flap (604) moveable along an axis transverse to an axis of rotation of the least one suction motor (104) to modulate the air prior to being sucked in by the least one suction motor (104).

8. An aerial vehicle (100) comprising:
a main body (102) having a plurality of suction motors (104), wherein each suction motor (104) of the plurality of suction motors (104) is to suck-in atmospheric air, amplify the sucked air and eject the amplified air; and
a plurality of thrust shoots (106), each coupled to a respective suction motor (104) of the plurality of suction motors (104), through each thrust shoot (106) of the plurality of thrust shoots (106), the ejected amplified air from the respective suction motor (104) passes out from an opening of a respective thrust shoot (106) of the plurality of thrust shoots (106),
wherein the air is modulated before being sucked in by each suction motor (104) of the plurality of suction motors (104) to create a differential thrust to manoeuvre the aerial vehicle (100).

9. The aerial vehicle (100) as claimed in claim 8, comprising:
a plurality of impellers (502), each disposed over a respective suction motor (104) of the plurality of suction motors (104);
wherein for each impeller (502) of the plurality of impellers (502), a different speed is set to create a differential thrust to manoeuvre the aerial vehicle (100).

10. The aerial vehicle (100) as claimed in claim 8,
wherein the main body (102) comprises a vent (602), disposed over the plurality of suction motors (104), to suck in atmospheric air from the top of the aerial vehicle (100);
wherein the vent (602) comprises a plurality of auxiliary flaps (604) and a plurality of axes, each axis of the plurality of axes is transverse to an axis of rotation of each suction motor (104) of the plurality of suction motors (104);
wherein each flap (604) of the plurality of auxiliary flaps (604) is moveable along a respective axis of the plurality of axes to modulate the air prior to being sucked in by each suction motor (104) of the plurality of suction motors (104).

11. An aerial vehicle (100) comprising:
a main body (102) having at least one suction motor (104), wherein the at least one suction motor (104) is to suck-in atmospheric air, amplify the sucked air and eject the amplified air; and
at least one thrust shoot (106) coupled to the at least one suction motor (104), through which the ejected amplified air from the at least one suction motor (104) passes out from an opening of the at least one thrust shoot (106),
wherein the sucked amplified air is modulated to create a differential thrust to manoeuvre the aerial vehicle (100).

12. The aerial vehicle (100) as claimed in claim 11, wherein the at least one thrust shoot comprises a directional vent disposed at the opening of the at least one thrust shoot to control the flow of air passed via the at least one thrust shoot.

13. The aerial vehicle (100) as claimed in claim 12, wherein the directional vent (302) comprises at least one flap (304) moveable along an axis transverse to a longitudinal axis of the at least one thrust shoot (106) to modulate the sucked amplified air to be passed out via the opening (108) of the at least one thrust shoot (106).
